(19) United States
(12) Patent Application Publication
(10) Pub. No.: US 2013/0150239 A1
(43) Pub. Date: Jun. 13, 2013

(54) AQUEOUS-MISCIBLE OR AQUEOUS-DISPERSIBLE, VOC-FREE BIOCIDAL COMPOSITIONS FOR THE ENHANCED INHIBITION OF GRAM-NEGATIVE BACTERIAL STRAINS, AND METHOD OF PREPARING THE SAME

(71) Applicants: Raman Premachandran, Saddle Brook, NJ (US); Karen Winkowski, Springfield, NJ (US)

(72) Inventors: Raman Premachandran, Saddle Brook, NJ (US); Karen Winkowski, Springfield, NJ (US)

(21) Appl. No.: 13/520,096

(22) PCT Filed: Jan. 6, 2011
(86) PCT No.: PCT/US2011/020322

§ 371 Date: Sep. 25, 2012

Related U.S. Application Data
(60) Provisional application No. 61/292,894, filed on Jan. 7, 2010.

(51) Int. Cl. A01N 43/80

(52) U.S. Cl. CPC A01N 43/80
USPC 504/116.1; 514/373

(57) ABSTRACT

Disclosed herein is an aqueous-miscible or aqueous-dispersible biocidal composition of BIT capable of exhibiting substantially enhanced biocidal activity with lesser minimum inhibitory concentration (MIC) level at faster kill rate of gram-negative bacterial strains. The biocidal composition of the present application comprises (i) BIT, (ii) at least one cationic polymer and/or at least one cationic amine surfactant, (iii) optionally one or more sequestering agents, (iv) optionally one or more aromatic aldehydes, and (v) optionally, at least one additive. The composition is volatile organic compounds (VOC) free, heat and cold stable, and has a pH of about 3.0 to about 8.5. Also, disclosed is a process for preparing the aqueous-miscible and aqueous-dispersible compositions and their applications in various fields.

### FIELD

This application relates to biocidal compositions for substantially enhanced inhibition of gram-negative bacterial strains, and more particularly, to a process for preparing aqueous-miscible or aqueous-dispersible, volatile organic compounds (VOC) free biocidal compositions comprising 1,2-benzisothiazolin-3-one.

### BACKGROUND

Isothiazolinones such as 1,2-Benzisothiazolin-3-one (referred to hereinafter as “BIT”) and 2-methyl-4-isothiazolin-3-one (referred to hereinafter as “MIT”) are effective industrial biocides, particularly effective in protecting aqueous media against microbiological spoilage. It is advantageous to deliver the BIT as a liquid formulation to combat against various microorganisms in numerous applications. Low solubility of BIT in aqueous medium limits the ability of this biocide to be formulated into aqueous based systems. Therefore, alternative approaches have been explored by the artisans to formulate and deliver liquid based BIT compositions.

U.S. Pat. No. 4,188,376 assigned to Imperial Chemical Industries Limited discloses a solution of alkali metal salts of BIT. These type of formulations are corrosive in nature due to their higher pH ranges as high as 12 or above which is unacceptable for use in emulsion paint or latex. Moreover, the higher pH of such formulations limits their utility in several applications as it causes “pH shock” and coagulation when added to the medium to be protected.

Various attempts have been made to formulate the liquid formulations of BIT in amines or ammonia and wherein they typically employ solvent based liquid carriers contributing to volatile organic compounds (VOC). These types of amine based formulations are not stable in low temperature conditions. For example, UK Pat. No. 1,191,253 and UK Pat. No. 1,330,531 disclose various amine salts of BIT with lack of stability under cold conditions. U.S. Pat. No. 4,923,887 discloses liquid formulations of BIT with ethoxylated (coconut alkyl)-amine, water, alcohols, 1,2-propylene glycol, dipropylene glycol, polyglycols, ether of glycols, or their mixture, as co-solvent. U.S. Pat. No. 5,276,047 discloses liquid formulations of BIT with triamines and triamine mixtures, water, glycols and alkylglycol ethers. The foregoing BIT formulations comprising amines are not appropriate for certain applications and these amines are volatile and have strong unpleasant odors. In general, amines are unacceptable for indirect and direct food contact applications as they can cause yellowing of certain water-based latex. The aforementioned amine solutions of BIT may not be suitable for use as biocides for in-can preservation.

U.S. Pat. No. 5,684,025 assigned to Huls America Inc. reveals liquid formulation of BIT having low VOC and wherein the formulation is free from amine and is stable for at least a few weeks at 0°-10° C. temperatures. U.S. Pat. No. 7,105,555 discloses a neutral pH, VOC-free, BIT composition which is stable at low temperatures for extended period of time.

U.S. Pat. No. 4,751,311 discloses BIT formulation with urea to address the low temperature stability issues; however they are limited by their higher pH ranges, i.e., 9.0 or above. US Pub. No. 20080280960 discloses aqueous alkaline formulations having a pH of >10 comprising 1,2-benzisothiazolin-3-one (BIT) and/or its alkali metal salts and tetramethylolacetylenediurea (TMAD), a formaldehyde releasing agent without solvents and/or co-solvents to have good long-term stability

Further, environmental friendly newer formulations are made with increased amounts of water to have reduced VOC resulting in cheaper products. These formulations have a drawback of being unstable under low and high temperature storage and wherein a brownish colloidal suspension is formed when trivalent metal or alkali hydrolyzable material are present as impurities. Such brownish colloidal suspension produced by absorbing alkali from the composition lead to loss in solubility of BIT. This seeded BIT will pull the colloidal suspension to the bottom of the container as sludge.

Additionally, BIT is widely used in various industrial applications to protect emulsion paints, adhesives, joint compounds, sealants, grouts, cements, slurries lattices, textile spin products, metal working fluids and etc. In general, the BIT based formulations combat a broad antimicrobial spectrum that covers bacteria, yeast and fungi. However, its efficacy to kill microorganism is not equally efficient across the entire spectrum of microorganisms. Moreover, BIT lacks in its efficiency to a particular type of microorganism and its kill rate may not be fast enough to prevent microbial spoilage of the material to be preserved. One such particular microorganism belongs to pseudomonas genus, a grain-negative microorganism. In order to fill this gap and to bring equal efficiency to the entire spectrum or to pseudomonas genus, several methods are employed in this field. One such method for this purpose is the use of combinations of one or more biocides to yield synergism to the composition. Unfortunately, such compositions are limited by their cost and regulatory issues.

In view of foregoing facts, there remains a need for aqueous, BIT based antimicrobial compositions which are slightly neutral to alkaline, VOC-free, heat and cold stable, cost-effective, commercially-viable and capable of exhibiting enhanced biocidal activity against gram-negative pseudomonas genus with lower range of minimum inhibitory concentration (MIC) and faster kill rate.

### SUMMARY

This application relates to aqueous-miscible or aqueous-dispersible, volatile organic compounds (VOC) free, heat and cold stable biocidal compositions having pH of about 3.0 to about 8.5 capable of exhibiting substantially enhanced biocidal activity via increased inhibition of gram-negative bacterial strains comprising (i) 1,2-benzisothiazolin-3-one, (ii) at least one cationic polymer and/or at least one cationic amine surfactant, (iii) optionally one or more sequestering agents, (iv) optionally one or more aromatic aldehydes and (v) at least one additive.

In certain aspects the present application provides substantially enhanced inhibition to gram-negative bacterial strains selected from the group comprising Escherichia species, Salmonella species, Shigella species, Enterobacteriaceae species, Pseudomonas species, Moraxella species, Helicobacter species, and/or Legionella species.

Another aspect of the present application is to provide heat and cold stable aqueous-dispersible or aqueous-miscible biocidal composition wherein the composition is stable for at least two years at room temperature or stable for at least 5 freeze/thaw cycles wherein the temperature is cycled from 50° C. to −24° C. in every 24 hours or stable for at least 4 weeks at about 50° C.

Yet another aspect of the present application is to provide aqueous-miscible or aqueous-dispersible biocidal compositions of BIT comprising one or more additional biocides selected from the group consisting of insecticides, acaricides, algicides, molluscicides, bactericides, herbicides, plant growth regulators and/or fungicides.

In accordance with one embodiment of the present application, there is provided a process for preparing an aqueous-miscible, volatile organic compounds (VOC)-free, heat and cold stable, biocidal composition comprising the steps of (i) preparing an aqueous glycolic dispersion of 1,2-benzisothiazolin-3-one (BIT) with continuous stirring; (ii) neutralizing the resultant obtained in the step (i) with at least one appropriate pH adjusting agents until it yields clear solution; and (iii) adding the (a) cationic polymer, (b) cationic surfactant, (c) other optional ingredients such as sequestering agents and aromatic aldehydes and (d) optionally, at least one additive to the resulting neutralized solution of step (ii) with thorough mixing until it yields clear transparent aqueous-miscible solution of biocidal composition.

In accordance with another embodiment of the present application, there is provided a process for preparing an aqueous-dispersible, volatile organic compounds (VOC)-free, heat and cold stable, biocidal composition comprising the steps of: (i) preparing an aqueous medium comprising uniformly dispersed particles of mixture of wetting agent, inert carrier and dispersing agent by means of appropriate stirring techniques; (ii) adding 1,2-benzisothiazolin-3-one and at least one cationic surfactant to the resultant aqueous uniform dispersion of step (i) grinding the resulting mixture for at least 30 minutes with zirconium beads as grinding media; (iii) incorporating (a) cationic polymer, (b) optional ingredients such as sequestering agents and aromatic aldehydes, and (c) optionally, at least one additive to the resultant uniform mixture of step (ii) and grinding the collective mixture with the help of zirconium beads as grinding media until the Hegmann number is 7.0 to yield an aqueous-dispersible biocidal composition.

Another preferred embodiment of the present application features suitable additives for preparing the desired aqueous-miscible or aqueous-dispersible composition. The additives are selected from the group comprising wetting agents, suspending agents, thickening agents, dispersing agents, preservatives, anti-microbial agents alone or in combination. The inert carrier for aqueous-dispersible composition is selected from the group comprising ground natural minerals, ground synthetic minerals and/or metal oxides.

In accordance with a further aspect of the present application, the aqueous-miscible or aqueous-dispersible biocidal composition of BIT prepared according to the above process is employed in the field of paint, building materials, stucco, concrete, caulks, sealants, joint compounds, adhesives, leather, wood, inks, pigment dispersions, metal working fluids, drilling mud, house hold, cleaning, detergent and/or clay slurries.

This application additionally describes an aqueous-dispersible or aqueous-miscible biocidal composition in various other deliverable forms including, but not limited to, emulsion, suspension and/or concentrate.

### DETAILED DESCRIPTION

While this specification concludes with claims particularly pointing out and distinctly claiming that, which is regarded as the invention it is anticipated that the invention can be more readily understood through reading the following detailed description of the application and study of the included examples.

This application is described in detail with reference to preferred embodiments featuring BIT, an Isothiazolinone biocide. However, it is believed that the invention can be practiced with other Isothiazolinone biocides such as methyl isothiazolinone, etc.

The present disclosure describes the current best mode for practicing the invention, Many modifications and variations present themselves to those skilled in the art without departing from the scope and spirit of this application.

When introducing elements of the present application or the preferred embodiments(s) thereof, the articles “a”, “an”, “the” and “said” are intended to mean that there are one or more of the elements. The terms “comprises”, “comprising”, “including”, “includes”, “has” and “having” or any other variations thereof are intended to be inclusive and mean that there may be additional elements other than the listed elements.

As used herein, the phrases “biocide”, “antimicrobial”, and “inhibiting microbial growth” describe the killing of, as well as the inhibition of or control of, biological growth including, but not limited to, bacteria, yeast, fungi, algae, caterpillar, insects, larvae, mildew, rodents, spider, worm and the like.

The term “about” can indicate a difference of 10 percent of the value specified. Numerical ranges as used herein are meant to include every number and subset of numbers enclosed within that range, whether particularly disclosed or not. All percentages, parts, proportions and ratios as used herein, are by weight of the total composition, unless otherwise specified.

This term “Cationic Polymers” means those polymers displaying at least one secondary amine or tertiary amine or quaternary ammonium group in their principal chain or branched chain or in the substituted form. Generally, these cationic polymers employed in the compositions of the present application have an average molecular weight between about 1000 to about 300000 or more. The cationic polymers advantageously utilized in the compositions of the present application fit in to a class that is well-known in the prior-art.

The term “Volatile Organic Compounds (VOC)-free” as used herein is referring to a composition of the present application means that no external solvent constituent has been added in the present aqueous composition at any point of time and it should be understood by one of ordinary skill in the art that residual solvents may be present inherently in commercially available or synthesized products which may or may not be part of the aqueous composition of the present application and wherein the inherent presence of residual solvent is not precluded by use of the term “Volatile Organic Compounds (VOC)-free”.

The term “sequestering agent” or “chelating agent” as used in this specification and claims relates to a compound which is capable of bonding or complexing a metal ion between two or more atoms of the compound, thereby neutralizing or controlling harmful effects of such metal ions. Holding or bonding of a metal ion is through combination of one or more different types of bonds including coordination and/or ionic bonds.

The term “water-miscible” or “aqueous-miscible” according to the present application means the entire composition is susceptible of being mixed with water or aqueous medium such that scattering is not observed when the composition is analyzed using dynamic light scattering or any other technique well-known in the prior-art relating to particle analysis.

As used herein, the term “water-dispersible” or “aqueous-dispersible” means that the biocidal composition is dispersed or exists in the aqueous medium as minute particles dispersed or suspended and often stabilized against flocculation and settling by the use of dispersing agents. The aqueous-dispersible composition of the present application exhibits scattering when analyzed using dynamic light scattering or any other technique well-known in the prior-art relating to particle analysis.

The patents and publications referred to herein are hereby incorporated by reference to the extent necessary to understand the present application.

The aqueous-miscible or aqueous-dispersible biocidal compositions of BIT are capable of exhibiting substantially enhanced biocidal activity with lower minimum inhibitory concentration (MIC) level at faster kill rate of gram-negative bacterial strains. The biocidal composition comprises (i) BIT, (ii) at least one cationic polymer and/or at least one cationic amine surfactants, (iii) optionally one or more sequestering agents, (iv) optionally one or more aromatic aldehydes, and (v) optionally, at least one additive. The composition is volatile organic compounds (VOC) free, heat and cold stable, having pH of about 3.0 to about 8.5.

One embodiment of the present application provides aqueous-dispersible or aqueous-miscible compositions for enhanced control or prevention of growth of gram-negative microorganisms employing at least one cationic polymer along with a desired biocide, BIT and wherein the cationic polymer is selected from the group consisting of homo or copolymers of polyamines, polyimines, polyalkyleneimines alone or in combination. The preferred polyalkyleneimines are polyethyleneimine (referred to hereinafter as “PEI”), polyisopropyleneimines and polypropyleneimines. The generic structure of the PEI of the present application is having a repeating unit of —[—CH₂—CH₂—NH—]—, and may be homopolymers, or polymers formed by the reaction of polyethylenimine with ethylene oxide or epichlorohydrin. The PEI is produced by polymerization of ethyleneimine and may not have complete linear structure, but instead may have a branched structure including primary, secondary and tertiary amino nitrogen atoms. Particularly, the linear or branched PEI compounds with one or more nitrogen comprising heterocyclic compounds are effectively being employed in the present application. The cationic polymer of the present application is obtained through any well-known polymerization methods such as free radical solution, emulsion, suspension, bulk polymerization and the like or stepwise polymerization. The molecular weight of the cationic polymer employed in the present application is preferably within the range of from about 3000 to about 300,000.

The commercially available suitable PEI's for the preparation of aqueous-miscible or aqueous-dispersible biocidal compositions include but are not limited to Lupasol®, Lupasol SC 61B®, Lupasol G-35®, Lupasol-P®, Lupasol-PS®, Lupasol-(water-Free)®, Polymin P® from BASF Corporation. The PEI's from Polymer Enterprises or Nippon Soda would include but are not limited to Epomin SP012®, Epomin P1050®, Epomin SP103®, Epomin SP003®, Epomin SP006® and in the similar lines various other PEI's suitable for use of present application include but are not limited to Polyazinidine®, Corcat®, Montek® and the like.

Cationic amine based surfactants are employed for the preparation of aqueous-dispersible or aqueous-miscible BIT compositions for the enhanced control or prevention of growth of gram-negative bacterial strains. The suitable amine based cationic surfactant for the present application is selected from the following non-limiting group of surfactants: primary amines, secondary amines, tertiary amines, quaternary amines, alkanolamines, mono-alkyl alkanolamines, di-alkyl alkanolamines, alkanolamines, alkyl mono alkanolamines, alkyl di-alkanolamines, alkylamines, mono-alkyl amines, di-alkyl amines, tri-alkylamines, alkoxylated amines, methoxylated alkylamines, ethoxylated alkylamines, alkoxylated alkanolamines, alkyl alkanolamines. The preferred cationic surfactants of the present application include but are not limited to (a) alkyl alkanolamines; and (b) alkyl tertiary amines.

Alkyl alkanolamines used in the present application have the following general formula (I), wherein R₁ and/or R₂ can be mutually independently hydrogen but both cannot be hydrogen, a linear or branched saturated or unsaturated C₁-C₂₀ aliphatic radical, which can optionally be mono or polysubstituted, a C₆-C₁₂ aryl radical, a C₇-C₁₄ araylaliphatic radical or a C₅-C₇ cycloaliphatic radical and R₃ can be linear or branched, saturated or unsaturated C₁-C₂₀ aliphatic radical, can optionally be mono or polysubstituted, a C₆-C₁₂ aryl radical, a C₇-C₁₄ araylaliphatic radical or a C₅-C₇ cycloaliphatic radical,

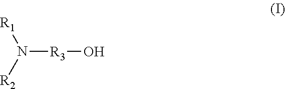

The representative alkyl alkanolamines include but not limited to methylaminoethanol, dimethylaminoethanol, methyldiethanolamine, ethylaminoethanol, diethylaminoethanol, dimethylamino-2-propanol, isopropylamino ethanol, disiopropylaminoethanol, butylaminoethanol, dibutylaminoethanol, butyldiethanolamine, tert-butylaminoethanol, N,N-diethylethanolamine (DEEA), N,N-dimethylethanolamine (DMEA), N-methyldiethanolamine (MDEA), N-methylethanolamine (NMEA). The commercially available and suitable alkyl alkanolamines for the preparation of aqueous-miscible or aqueous-dispersible biocidal compositions of the present application would include but are not limited to Alpamine N41®, Alpamine® F4520, Alpamine® F4680, Alpamine® F4620 alone or combination thereof.

The alkylamines of the present application have the following general formula (II) wherein R₄, R₅ and R₆ can be independently hydrogen but not all three can be hydrogen, a linear or branched, saturated or unsaturated C₁-C₂₀ aliphatic radical, which can optionally be mono or polysubstituted, or a C₆-C₁₂ aryl radical, a C₇-C₁₄ araylaliphatic radical or a C₅-C₇ cycloaliphatic radical.

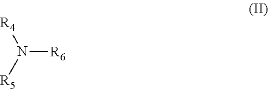

The preferred alkyl amines include but not limited to monoethylamine, diethylamine, triethylamine, monoisopropylamine, diisopropylamine, monobutylamine, dibutylamine, tributylamine, monoamylamine, dimethylethylamine, dimethyl isopropylamine, ethyldiisopropylamine, sec-butylamine, tetramethylpropylenediamine, diethylaminopropylamine, 3-methoxypropylamine, dimethylaminopropylaminopropylamine, 3-isopropoxypropylamine, decyl dimethyl tertiaryamine, nonyl dimethyl tertiaryamine, octyl dimethyl tertiaryamine, heptyl dimethyl tertiaryamine, hexyl dimethyl tertiaryamine, pentyl dimethyl tertiaryamine, butyl dimethyl tertiaryamine, propyl dimethyl tertiaryamine, dimethyl cocamine, dimethyl palmitamine, dioctylamine, dimethyl stearamine, dimethyl soyamine, soyamine, myristyl amine, tridecyl amine, ethyl stearylamine, N-tallowpropane diamine, ethoxylated stearylamine, dihydroxy ethyl stearylamine, arachidylbehenylamine, dimethyl lauramine, stearylamine hydrochloride, soyamine chloride, stearylamine formate, N-tallowpropane diamine dichloride, amodimethicone, stearamido propyl dimethyl amine, stearamidopropyl dimethylamine citrate, palmitamidopropyl diethylamine, cocamidopropyl dimethylamine lactate, distearyldimonium chloride, dicetyldimonium chloride, guar hydroxypropyltrimonium chloride, and the like. Additional information on useful cationic surfactants for preparing aqueous-miscible or aqueous-dispersible BIT composition is well described in McCutcheon's Detergents and Emulsifiers, North American Ed., 1982 and Kirk-Othmer, Encyclopedia of Chemical Technology, 3rd Ed., Vol. 22, pp. 346-387, the contents of which are included herein by reference. The commercially available alkylamines for aqueous-miscible or aqueous-dispersible biocidal compositions of the present application would include but are not limited to AT-1095, AT-1295, AT-1495, AT-1695A, AT-1895A, AT-1270, AT-121416, AT-1214 and/or AT-1822A manufactured and marketed by PG Chemicals.

In a preferred embodiment of the application, the sequestering or chelating agent is employed for the preparation of aqueous-dispersible or aqueous-miscible compositions in order to provide the enhanced control or prevention of growth of gram-negative microorganisms and wherein the suitable organic or inorganic sequestering or chelating is selected from the group comprising polyols, gluconates, sorbitals, mannitols, carbonates, hydroxamates, catechols, x-amino carboxylates, alkanolamines, metal-ion sequestrants, hydroxy-carboxylic acids, aminocarboxylic acids, amino polycarboxylic acids, polyamines, polyphosphates, phosphonic acids, crown ethers, amino acids, polycarboxylic acids, cyclodextrin, phosphonates, polyacrylates or polymeric polycarboxylates, condensed phosphates. Suitable sequestering or chelating agents of the present application include but are not limited to acetic acid, adenine, adipic acid, ADP, alanine, alanine, albumin, arginine, ascorbic acid, asparagine, aspartic acid, ATP, benzoic acid, n-butyric acid, casein, citraconic acid, citric acid, cysteine, dehydracetic acid, desferri-ferrichrysin, desferri-ferrichrome, desferri-ferrioxamin E, 3,4-dihydroxybenzoic acid, diethylenetriaminepentaacetic acid (DTPA), hydroxylpropylenediaminetetraacctic acid (DPTA), dimethylglyoxime, dimethylpurpurogallin, EDTA, formic acid, fumaric acid, globulin, gluconic acid and its alkali metal salts, glutamic acid, glutaric acid, glycine, glycolic acid, glycylglycine, glycylsarcosine, guanosine, histamine, salicylic, pimalic and sulfamic acid, salicylic, glutaric, malonic acid, 1,10-phenanthroline, 2-pyridylacetic acid, 5-formylfuran sulfonic acid, N-tris-(hydroxymethyl)methyl-2-aminoethanesulfonic acid, itaconic acid, chelidonic acid, 3-methyl-1,2-cyclopentanedione, glycolamide, histidine, 3-hydroxyflavone, inosine, iron-free ferrichrome, isovaleric acid, itaconic acid, kojic acid, lactic acid, leucine, lysine, maleic acid, malic acid, methionine, methylsalicylate, nitrilotriacetic acid (NTA), ornithine, orthophosphate, oxalic acid, oxystearin, phenylalanine, phosphoric acid, phytate, pimelic acid, pivalic acid, polyphosphate, praline, propionic acid, purine, pyrophosphate, pyruvic acid, riboflavin, salicylaldehyde, salicyclic acid, sarcosine, serine, sorbitol, succinic acid, tartaric acid, tetrametaphosphate, thiosulfate, threonine, trimetaphosphate, triphosphate, tryptophan, uridine diphosphate, uridine triphosphate, n-valeric acid, valine, xanthosine, triethylenetetraaminehexaacetic acid, N,N′-bis(o-hydroxybenzyl)ethylenediamine-N,N′ diacteic acid, ethylenebis-N,N′-(2-o-hydroxyphenyl)glycine, acetohydroxamic acid, desferroxamine-B, disulfocatechol, dimethyl-2,3-dihydroxybenzamide, mesitylene catecholamide (MECAM), 1,8-dihydroxynaphthalene-3,6-sulfonic acid, and 2,3-dihydroxynaphthalene-6-sulfonic acid, siderophores molecules, N,N-dicarboxymethyl-2-aminopentanedioic-acid, diethylenctriaminepcntaacetic-acid, ethylene-diaminetetraacetates, nitriloacetates or N-(2-hydroxyethyl)nitrilodiacetates), 2,2-dichloropropionic acid, 2,2-dibromobutyric acid, trifluoroacetic acid, tribromoacetic acid, trichloroacetic acid, 2,3-dibromopropionic acid, 2,2-dichlorovaleric acid, 3-nitropropionic acid, triiodoacetic acid, 3(2,2,2-trichloroethoxy)propionic acid, 4-nitro-2-chlorobutyric acid, 2-bromo-2-nitropropionic acid, 2-nitroacetic acid, 2,4-dihydroxyphenyl acetic acid, 2,4-dichlorophenyl acetic acid, 3(2′,4′-dibromophenoxy)propionic acid, 3(3′,5′-dinitrophenoxy)propionic acid, 3-phenyl-2,3-dibromopropionic acid, 3,5-dinitrosalicylic acid, 3(3′-bromo-4′-nitrophenyl)propionic acid, 3(3′,4′-dihydroxyphenyl)propionic acid alone or in combination. Further information on sequestering and chelating agents is disclosed in T. E. Furia, CRC Handbook of Food Additives, 2nd Edition, pp. 271-294 (1972), and M. S. Peterson and A. M. Johnson (Eds.), Encyclopedia of Food Science, pp. 694-699 (1978) hereby incorporated herein by reference in their entirety.

According to one aspect of the application, the aromatic aldehydes are optionally employed to prepare both the aqueous-miscible and aqueous-dispersible composition of BIT. The aldehydes are employed to enhance the activity of the proposed compositions through increased solubilization of the active biocidal ingredients of the compositions. The preferred aromatic aldehydes of the present application include but are not limited to benzaldehyde, salicylaldehyde, naphthaldehyde and their respective substituted derivatives and wherein said aldehydes will preferably be substituted at one or more positions with the any one or more of the following substituent groups including but not limited to halogens, linear or branched chain alkyl radicals having C₂-C₁₀, cycloaliphatic radicals, aryl, phenyl, alkoxy, aryloxy, phenoxy, acyloxy, benzyloxy, acetoxy, hydroxy, sulfo, amino and/or nitro.

The compositions of the present application preferably include one or more pH adjusting agents to maintain the medium at required pH. The compositions can have any suitable pH which is desired for the composition's activity and stability. The pH of the compositions can range anywhere from about 3.5 to about 8.5. The desired pH of the composition can be obtained by employing any suitable inorganic bases such as sodium hydroxide, ammonium hydroxide and potassium hydroxide, or amines such as triethanol amine, diethanol amine or monoethanol amine. The acidic agents employed to adjust the pH of the composition would include but are not limited to hydrochloric acid, acetic acid, salicylic acid, citric acid, sulfamic acid alone or in combination. Some non-limiting examples of suitable buffers include phosphates, pyrophosphate and its salts, metaphosphate and its salts, carbonic acid and its salts, hydroxylammonium, adidic acid and its salts, maleic acid and its salts, and ascorbic acid and its salts.

In a preferred embodiment of the present application, there is provided aqueous-miscible or aqueous-dispersible compositions of BIT capable of exhibiting substantially enhanced biocidal activity via enhanced inhibition of gram-negative aerobic and/or anaerobic bacterial strains and wherein the specific bacterial strains are selected from the group comprising Escherichia species, Salmonella species, Shigella species, Enterobacteriaceae species, Pseudomonas species, Moraxella species, Helicobacter species, and/or Legionella species. The preferred Pseudomonas species would include but are not limited to P. putida, P. mendocina, P. fluorescens, P. olevorans, P. alcolipha, P. aeruginosa (ATCC10145) and P. aeruginosa (filed isolate). Wherein P. aeruginosa group: P. areuginosa, P. alcaligenes, P. anguilliseptica, P. argentinensis, P. borbori, P. citronellolis, P. flavescens, P. mendocina, P. nitroreducens, P. oleovorans, P. pseudoalcaligenesm, P. resinovorans, P. straminea, P. chlororaphis group: P. aurantiaca, P. aureofaciens, P. chlororaphis, P. fragi, P. lundensis, P. taetrokns; P. fluorescens group: P. Antarctica, P. azotoformans, ‘P. blatchfordae’, P. brassicacearum, P. brenneri, P. cedrina, P. corrugate, P. fluorescens, P. gessardii, P. libanensis, P. mandelii, P. marginalis, P. mediterranea, P. meridian, P. migulae, P. mucidolens, P. orientalis, P. panacis, P. proteolytica, P. rhodesiae, P. synxantha, P. thivervalensis, P. tolaasii, P. veronii, P. pertucinogena group: P. denitrificans, P. pertucinogena, P. putida group: P. cremoricolorata, P. fitiva, P. monteilii, P. mosselii, P. oryzihabitans, P. parafulva, P. plecoglossicida, P. putida, P. stutzeri group: P. belearica, P. luteola, P. stutzeri, P. syringae group: P. amygdale, P. avellanae, P. caricapapayae, P. cichorii, P. coronafaciens, P. ficuserectae, P. helianthi, P. meliae, P. savastanoi, P. syringae, P. tomato, P. viridiflava; incertae sedis: P. abietaniphila, P. acidophila, P. agarici, P. akaliphila, P. alkanolytica, P. amyloderamosa, P. asplenii, P. azotifigens, P. cannabina, P. coenobios, P. congelans, P. costantinii, P. cruciviae, P. deMiensis, P. excibis, P. extremorientalis, P. frederiksbergensis, P. fitscovaginae, P, gelidicola, P. grimontii, P. indica, P. jessenii, P. jinjuensis, P. kilonensis, P. knackmussii, P. koreensis, P. lini, P, lutea, P. moraviensis, P. otitidis, P. pachastrellae, P. palleroniana, P. papaveris, P. peli, P. perolens, P. poae, P. pohangensis, P. psychrophila, P. psychrotolerans, P. rathonis, P. reptilivora, P. resiniphila, P. rhizosphaerae, P. rubescens, P. salomonii, P. segitis, P. septica, P. simiae, P. suis, P. thermotolerans, P. tremae, P. trivial's, P. turbinellae, P. tuticorinensis, P. umsongensis, P. vancottverensis, P. vranovensis and/or P. xanthomarina.

The aqueous-miscible or aqueous-dispersible compositions of BIT are evaluated for their efficacy against gram-negative microbial strains by serial dilution in trypticase soy broth. The broths can be inoculated with various gram-negative bacterial strains obtained from field and from appropriate cultures. After incubating the inoculated broths for 24 hours at 32° C., those tubes did not become cloudy in the serial dilution method were smeared onto tryptic soy agar and incubated for 24 hours at 32° C. The point at which no growth was detected is considered as minimum inhibitory concentration (MIC) determination. Further the rate of kill of various compositions of the present application is also determined by employing the suitable methods that are known to a person skilled in the art.

According to one embodiment of the present application it is desired to employ one or more VOC-free solvents for the preparation of aqueous-miscible or aqueous-dispersible composition. These solvents are selected from the group consisting of but are not limited to glycols, polyglycols, ethers of glycol, esters of glycol, cyclic diols, non-cyclic diols, glycerols, ethers or esters of glycerol, mixture of glycerols and/or mixture of polyglycerols. The preferred glycols of the application are ethylene glycol, 1,2-propylene glycol, 1,3-propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, 3-methyl-1,5-pentanediol, 2,3-dimethyl-2,3-butanediol, 2,4-dimethyl-2-ethyl-hexane-1,3-diol, 2,2-dimethyl-1,3-propanediol, 2-ethyl-2-butyl-1,3-propanediol, 2-ethyl-2-isobutyl-1,3-propanediol, 1,2-butanediol, 1,3-butanediol, 1,4-butanediol, 1,4-pentanediol, 1,5-pentanediol, 1,6-hexanediol, 2,2,4-tetra methyl-1,6-hexanediol, thiodiethanol, 1,2-cyclohexanedimethan-ol, 1,3-cyclohexanedimethanol, 1,4-cyclohexanedimethanol, 2,2,4-trimethyl-1,3-pentanediol, 2,2,4-tetramethyl-1,3-cyclobutanediol, p-xylenediol, hydroxypivalyl hydroxypivalate, 1,10-decanediol and/or hydrogenated bisphenol A. The appropriate polyols of the present application would include, but are not limited to, trimethylolpropane (TMP), pentaerythritol (PE), trimethylolethane, erythritol, threitol, dipentaerythritol, sorbitol, glycerine, and the like. Several apt polypropylene glycols of the present application would include that are sold by the Dow Chemical Company under the trade names PT250, PT700, PT3000, P425, P1000TB, P1200, P2000, P3000TB, and/or P4000.

The glycerol for the present application is selected from group consisting of diglycerol, triglycerol, tetraglycerol, pentaglycerol, hexaglycerol, heptaglycerol, octaglycerol, oligomer, ethylene glycol diglycidyl ether, polyethylene glycol diglycidyl ether, glycerol polyglycidyl ether, diglycerol polyglycidyl ether, polyglycerol polyglycidyl ether, sorbitol polyglycidyl ether, pentaerythritol polyglycidyl ether, propylene glycol diglycidyl ether, and propylene glycol diglycidyl ether and a combination thereof.

The “polyglycerol” (referred to hereinafter as PG) useful herein includes an oligomeric and/or polymeric chain composed of monomeric glycerol (i.e., HOCH₂CH(OH)CH₂OH) connected by ether linkages at their hydroxyl residue. The typical number of glycerol monomer units in a particular polyglycerol is characterized by a number. According to the present application, the isolated or purified polyglycerol polyol ingredients of the present application may contain, on average, from about 2 to about 20 monomer glycerol units. However, the polyglycerols suitable for the present application would include PG2, PG3, PG4, PG5, PG6, PG7, PG8, PG9, PG10, PG11, PG12, PG13, PG14, PG15, PG16, PG17, PG18, PG19, PG20, and a combination thereof. The commercially available polyglycerol for the present application are Polyglycerol-3 (Solvay), Polyglycerol-4 (Solvay), Polyglycerol-5, Polyglycerol-6, and/or Polyglycerol-10.

The composition according to the present application comprises organic surface-active agents to assist in achieving thorough and complete miscibility of the ingredients of the aqueous-miscible composition. The organic surface-active material is preferably anionic, nonionic or ampholytic in nature. It is preferred to employ anionic surface-active agents. Examples of useful anionic surfactants include but are not limited to aliphates, abietates, hydroxyalkanesulfonates, alkanesulfonates, dialkylsulfosuccinates, straight-chain alkylbenzenesulfonates, branched alkylbenzenesulfonates, alkylnaphthalenesulfonates, alkylphenoxy polyoxyethylene propylsulfonates, salts of polyoxyethylene alkylsulfophenyl ethers, sodium N-methyl-N-oleyltaurates, monoamide disodium N-alkylsulfosuccinates, petroleum sulfonates, sulfated castor oil, sulfated tallow oil, salts of sulfuric esters of aliphatic alkylesters, salts of alkylsulfuric esters, sulfuric esters of polyoxyethylenealkylethers, salts of sulfuric esters of aliphatic monoglycerides, sodium salt of the monosulfated monoglyceride of hydrogenated coconut oil fatty acids, salts of sulfuric esters of polyoxyethylene alkylphenylethers, salts of alkylphosphoric esters, salts of phosphoric esters of polyoxyethylenealkylethers, salts of phosphoric esters of polyoxyethylenealkylphenylethers, partially saponified compounds of styrenemaleic anhydride copolymers, partially saponified compounds of olefin-maleic anhydride copolymers, naphthalenesulfonateformalin condensates, higher alkyl sulfates such as sodium lauryl sulfate, alkyl aryl sulfonates such as sodium dodecyl benzene sulfonate, higher alkyl sulfoacetates, higher fatty acid esters of 1,2-dihydroxy propane sulfonate. Particularly preferred among these anionic surfactants are dialkylsulfosuccinates and their alkali metal salts, salts of alkylsulfuric esters, and alkylnaphthalenesulfonates.

In another embodiment of the present application, the aqueous-miscible or aqueous-dispersible biocidal BIT composition is stable for at least two years at room temperature or stable for at least about 5 freeze/thaw cycles wherein temperature is cycled from 50° C. to −24° C. in every 24 hours or stable for at least 4 weeks at about 50° C.

In order to prepare an aqueous-dispersible or aqueous-miscible composition of BIT, the aqueous medium can be any type of water known in the art for this purpose and preferably selected from distilled water, de-ionized water, double distilled water, triple distilled water, tap water, de-mineralized water, reverse-osmosis water alone or in combination thereof.

In accordance with one aspect of the present application, there is provide a process for preparing an aqueous-miscible, volatile organic compounds (VOC)-free, heat and cold stable, biocidal composition comprising the steps of (i) preparing an aqueous glycolic dispersion of 1,2-benzisothiazolin-3-one with continuous stirring; (ii) neutralizing the resultant obtained in the step (i) with at least one appropriate pH adjusting agents until it yields clear solution; and (iii) adding the (a) cationic polymer, (b) cationic surfactant, (c) other optional ingredients such as sequestering agents and aromatic aldehydes and (d) optionally, at least one additive to the resulting neutralized solution of step (ii) with thorough mixing until it yields clear transparent aqueous-miscible solution of biocidal composition.

Another important aspect of the present application is to deliver aqueous-dispersible compositions. The process for preparing a aqueous-dispersible, volatile organic compounds (VOC)-free, heat and cold stable, biocidal composition comprises the steps of: (i) preparing an aqueous medium comprising uniformly dispersed particles of mixture of wetting agent, inert carrier and dispersing agent by means of appropriate stirring techniques; (ii) adding 1,2-benzisothiazolin-3-one and at least one cationic surfactant to the resultant aqueous uniform dispersion of step (i) and grinding the resulting mixture for at least 30 minutes employing zirconium beads as grinding media; and (iii) incorporating (a) cationic polymer, (b) optional ingredients such as sequestering agents and aromatic aldehydes and (c) optionally, at least one additive to the resultant uniform mixture of step (ii) and grinding the collective mixture employing zirconium beads as grinding media until the Hegmann number is 7.0 to yield aqueous-dispersible biocidal dispersion composition.

The process for preparing the aqueous-dispersible composition comprises use of an inert carrier for the formation of uniformly dispersed particles of ingredients. The suitable inert carrier is selected from the group consisting of finely ground natural minerals, ground synthetic minerals and/or metal oxides and preferably selected from the group consisting of clays, talc, chalk, quartz, attapulgite, montmorillonite or diatomaceous earth, perlite or “expanded perlite”, zeolite including microphorous aluminosilicate, highly-disperse silica, alumina, mica, wollastonite, silicate or aluminosilicate. Clay minerals of kandite group, for example kaolinite, dickite, nacrite and halloysite, have been found to be particularly advantageous. “Kaolinite” includes kaolin type clays, ball clays, fire clays and china clays. Such clays occur in nature in the form of kaolinite plus other minerals, eg. one or more of illite, mica, quartz and feldspar. The kandite clay mineral may be used in its natural, hydroxylated or hydrous state. Wherein the aluminosilicate comprises of smectite clay, it may comprise for example one or more of bentonite, hectorite and saponite. The preferred silicates are oxidized silicon compounds such as SiO₃, SiO₄, Si₂O₆ and Si₂O₇.

Preferred inert carriers include silicate clay, aluminosilicate clay including kaolin clay composed of the mineral kaolinite, an aluminosilicate and a hydrated silica of alumina with a composition of about 46% silica, about 40% alumina and about 14% water. Examples of suitable kaolin clay particles are Huber 80, Huber 90, Polygloss 80 and Polygloss 90. Other suitable examples of natural refined kaolin clay are Dixieclay®, Par® and Bilt-Plates® 56 from R.T. Vanderbilt Company, Inc.

In an embodiment, the metal or metal compounds are selected from any one or more of the groups IIIB, IVB, VB, VIB VIIB or VIIIB of chemical periodic system and preferably they are employed in the form of salts, colloidal metal oxides, aluminates, silicates, titanates, zincate, zirconates, zircoaluminate, aluminium titanate, aluminium silicate, stannates or argentates of aluminum, silicon, titanium, zirconium or copper, cobalt, cadmium, nickel, tin, silver, zinc, lead, bismuth, chromium, manganese, iron or arsenic alone or in combination thereof. The preferred inert carrier of the present application is titanium dioxide with the concentration from 0.01% to 10%, preferably from 1.0% to 5.0%.

The fine particles mixture of aqueous-dispersible composition is obtained through the known comminution methods including but not limited to triturating, grinding and/or milling method in order to achieve the resultant mixture having a particle size of less than about 0.5 μm to about 10.0 μm and preferably about 0.5 μm to about 3.0 μm. Particle size reduction of the composition is carried out preferably in mills, such as ball mills, agitator ball mills, circulating mills (agitator ball mills with pin grinding system), disk mills, annular chamber mills, double cone mills, triple roll mills and/or batch mills.

Grinding or milling media useful for the preparation of fine particles mixture of the aqueous-dispersible composition include, but are not limited to, steel shots, carbon steel shots, stannous steel shots, chrome steel shots, tungsten carbide, silicon nitride, silicon, carbide, ceramic, zirconium based media including zirconia, zirconium silicate, zirconium oxide, stabilized zirconia such as yttrium stabilized zirconia, calcium stabilized zirconia, magnesium stabilized zirconia, cerium stabilized zirconia, stabilized magnesium oxide, stabilized aluminum oxide and the like. A particular preferred grinding media of the present composition is zirconium based.

A “wetting agent” or a surfactant is a substance, which, at low concentrations, alters the interfacial tension and thus will stabilize the aqueous-dispersible system or interacts between the surface of a particles and the surrounding liquid to improve the dispersion. The organic surface-active material is preferably anionic, nonionic or ampholytic in nature. Wetting agents are amphipathic in structure having both polar and non-polar regions in the same molecule. Examples of surface active agents used in the formulation arts are given in Corrigan, O. I.; Healy, A. M. “Surfactants in Pharmaceutical Products and Systems” in Encyclopedia of Pharmaceutical Technology 2^{nd} ed. Taylor and Francis, 2006, pp 3583-3596.

Examples of water-soluble nonionic surfactants are condensation products of ethylene oxide with various reactive hydrogen-containing compounds reactive therewith having long hydrophobic chains (e.g. aliphatic chains of about 12 to 20 carbon atoms), which condensation products (“ethoxamers”) contain hydrophilic polyoxyethylene moieties, such as condensation products of poly(ethylene oxide) with fatty acids, fatty alcohols, fatty amides, polyhydric alcohols (e.g. sorbitan monosterate), polypropyleneoxide (e.g. Pluronic materials), poloxamers, polyoxyethylene sorbitan esters, fatty alcohol ethoxylates, alkylphenol ethoxylates, tertiary amine oxides, tertiary phosphine oxides and/or dialkyl sulfoxides. Suitable amphoteric surfactants include without limitation derivatives of C₈₋₂₀ aliphatic secondary and tertiary amities having an anionic group such as carboxylate, sulfate, sulfonate, phosphate or phosphonate.

The aqueous-dispersible composition additionally comprises an acetylene glycol surface active agent and/or an acetylene alcohol surface active agent to reduce the surface tension. Particularly preferred surface active agent is selected from acetylene glycol group of compounds and wherein the preferred compounds are 2,4,7,9-tetramethyl-5-decyne-4,7-diol, 3,6-dimethyl-4-octyne-3,6-diol, and 3,5-dimethyl-1-hexyn-3-ol. The commercially available acetylene glycol surface active agents would include but are not limited to Surfynol series 61, 104, 82, 440, 465, 485, TG and CT-111 CT-121, CT-131, CT211 produced by Air Products and Chemicals, Inc., and Olfine series STG and E1010, supplied by Nisshin Chemical Industry Co., Ltd. These surface active agents are preferably used in amounts of 0.01 to 10% by weight, particularly 0.1 to 2% by weight, based on the total aqueous dispersion composition.

The dispersing agents are selected from conventional organic polymeric dispersants that are known in the art for preparing aqueous-dispersible BIT compositions and suitable dispersing agent would be readily available to a person skilled in the art from the prior-art. For illustration, the dispersants may be selected from polyelectrolytes such as polyacrylates and copolymers having polyacrylate compounds, for example various salts of polyacrylic acid compounds, sodium hexametaphosphates, polyphosphoric acid, condensed form of sodium phosphate, alkanolamines, and other reagents commonly used for this function, Exceptional dispersing agents would include poly (methylvinyl ether-co-maleic acid) partially neutralized with sodium hydroxide (EasySperse, EaseySperse P20 by ISP, Wayne N.J.) and non-ionic copolymers including but not limited to EO/PO block copolymers or poloxamers such as Pluronics (for e.g. L101&P103) from BASF, polymers of acrylic and methacrylic acid, C₁₁-C₁₅ secondary ethoxylated alcohols and diols, PEG-PLGA-PEG copolymers and polyether polyols. Additional examples of suitable dispersants would include sodium silicate, sodium carbonate, lignosulphonic acid salts (e.g. Polyfon, Ufoxane or Marsperse), a sulfonated naphthalene/formaldehyde condensate (e.g. Morwet), a block copolymer with pigment affinic group (e.g. Disperbyck 190), 1,4 bis-(2-ethylhexyl)-sodium-sulfosuccinate (e.g. Triton GR PG 70), Polyether-polycarbonate sodium salt (e.g. Ethacryl P), maleic acid-olefin co-polymer (e.g. Vultamol NN 4501), ammonium polyacrylate (e.g. Dispex GA 40), C₆-C₁₅ secondary alcohol and alkyl aryl sulfonate (e.g. Zetasperse 2300) and alkyl naphthalene sulfonate (e.g. Agnique), henolsulphonic or naphthalenesulphonic acid salts, 2-amino-2-methyl-1-propanol, tri and tetra sodium salts of pyrophosphate and polyphosphate and water-soluble sodium or ammonium salts of polyacrylates, polycarboxylates and polymethacrylates.

Various other compounds or additives are added to the aqueous composition to enhance or obtain desired properties. The additives include, but are not limited to, antifoams, plasticizers, surfactants, suspending agents, wetting agents, fillers, coloring agents, dispersing agents, thickening agents, thixotropic agents, antifreezing agents, pH adjusting agents, corrosion inhibitors, ultraviolet light stabilizers, antioxidants, co-solvents, anti-freeze agents, stabilizers, scale inhibitors, anti-corrosion additives, preservative, antimicrobial agents and the like. The aqueous-miscible or aqueous-dispersible composition of the present application may also contain other additives depending upon the particular use intended for the composition. Additional components optionally included in the composition can be for example additional polymeric materials, detergents, botanical extracts, perfumes, fragrances, thickeners, humectants, anti-corrosion agents, colorants, buffers, hydrotropes, anti-soil agents and enzymes.

Alternatively, it is a feature of this application, that the aqueous composition comprising BIT and at least one potentiating agents can be delivered in different deliverable forms including but not limited to concentrates, suspensions, emulsions, powders or granules to be incorporated directly in the amounts required for use.

The compositions of this application additionally comprise one or more of other biocidal active ingredients in order to enhance the spectrum of microbicidal activity of the composition. The additional biocide(s) are selected from the following non-limiting group of biocidal compounds: insecticides, acaricides, algicides, molluscicides, bactericides, herbicides, plant growth regulators, fungicides and the like. Addition of these biocide compounds to the present composition system yields increased activity via enhanced antibacterial spectrum.

The preferred additional biocides employed in the present application would include but are not limited to 3-allyloxy-1,2-benzoisothiazol-1,1-dioxide; basic copper chloride; basic copper sulfate; 1,2-benzisothiazoline-3-one; 2-Methyl-4-isothiazoline-3-one; methyl-N-(1H-benzoimidazol-2-yl)carbamate; 2-(tert-butylamino)-4-(cyclopropylamino)-6-(methylthio)-s-triazine; 2-tert-butylamino-4-ethylamino-6-methylmercapto-s-triazine; S—N-butyl-5′-para-tert-butylbenzyl-N-3-pyridyldithiocarbonylimidate; 2-chloro-1-(3-ethoxy-4-nitrophenoxy)-4-(trifluoromethyl)benzene; 4-chlorophenoxy-3,3-dimethyl-1-(1H,1,3,4-triazol-1-yl)-2-butanone; α-[2-(4-chlorophenyl)ethyl]-α-(1,1-dimethylethyl)-1H-1,2,4-triazole-1-ethanol; copper 8-quinolinate; cycloheximide; bis-(dimethyldithiocarbamoyl)disulfide; 11-dehydrodibenzo(b,f)azepine; 2,4-dichloro-6-(0-chloroanilino)-1,3,5-triazine; 1,4-dichloro-2,5-dimethoxybenzene; N′-dichlorofluoromethylthio-N,N-dimethyl-N-phenyl sulfamide; 2,3-dichloro-1,4-naphthoquinone; 2,6-dichloro-4-nitroaniline; 4,5-dichloro-2-N-octyl-4-isothiazolin-3-one; N-(3,5-dichlorophenyl)-1,2-dimethylcyclopropane-1,2-dicarboxyimide; N′-(3,4-dichlorophenyl)-N,N-dimethylurea; 1-[2-(2,4-dichlorophenyl)-4-ethyl-1,3-dioxorane-2-ylmethyl]-1H,1,2,4-triazol; N-(3,5-dichlorophenyl)succinamide; 1-[[2(2,4-dichlorophenyl)-4-propyl-1,3-dioxolan-2-yl]methyl]1-H-1,2,4-triazole; N-2,3-dichlorophenyltetrachlorophthalamic acid; 3-(3,5-dichlorophenyl)-5-ethenyl5-methyloxazolizine-2,4-dione; 2,3-dicyano-1,4-dithioanthraquinone; N-(2,6-diethylphenyl)-4-methylphthalimide; N-(2,6-p-diethylphenyl)phthalimide; 5,6-dihydro-2-methyl-1,4-oxathine-3-carboxanilide; 5,6-dihydro-2-methyl-1,4-oxathine-3-carboxanilido-4,4-dioxide; diisopropyl 1,3-dithiolane-2-iridene malonate; N,N-diisopropyl S-benzylphosphorothioate; 2-dimethylamino-4-methyl-5-N-butyl-6-hydroxypyrimidine; diethyl 2-dimethoxyphosphinothioylsulfanylbutanedioate; bis-(dimethyldithiocarbamoyl)ethylenediamine; 5-ethoxy-3-trichloromethyl-1,2,4-thiaziazole; ethyl-N-(3-dimethylaminopropyl)thiocarbamate hydrochloride; O-ethyl S,S-diphenyldithiophosphate; 3,3′-ethylene-bis-(tetrahydro-4,6-dimethyl-2H-1,3,5-thiadiazine-2-thione); 3-hydroxy-5-methylisooxazole; 3-iodo-2-propargyl butyl carbamate; iron methanearsonate; 3′-isopropoxy-2-methylbenzanilide; 1-isopropylearbamoyl-3-(3,5-dichlorophenyl)hydantoin; kasugamycin; manganese ethylene-bis-(dithiocarbamate); 1,2-bis-(3-methoxycarbonyl-2-thioureido) benzene; methyl-1(butylcarbamoyl)-2-benzimidazolecarbamate; 5-methyl-10-butoxycarbonylamino-10; 3-methyl-4-chlorobenzthiazol-2-one; methyl-D,L-N-(2,6-dimethylphenyl)-N-(2′-methoxyacetyl)-alaninate; S,S-6-methyl-quinoxaline-2,3-di-yldithiocarbonate 5-methyl-s-triazol-(3,4-b)benzthiazole; nickel dimethyldithiocarbamate; 2-octyl-2H-isothiazol-3-one; 2-oxy-3-chloro-1,4-naphthoquinone copper sulfate; pentachloronitrobenzene; (3-phenoxyphenyl)methyl(+/−)-cis,trans-3-(2,2-dichloroethenyl)-2,2-dimethylcyclo-propanecarboxylate; polyoxine; potassium N-hydroxymethyl-N-methyldithiocarbamate; N-propyl-N-[2-(2,4,6-trichlorophenoxy)ethyl]-imidazol-1-carboxamide; 2-pyridinethiol-1-oxide sodium salt; sodium pyrithione; N-tetrachloroethylthio-4-cyclohexene-1,2-dicarboxyimide; tetrachloroisophthalonitrile; 4,5,6,7-tetrachlorophthalide; 1,2,5,6-tetrahydro-4H-pyrrolol-[3,2,1-i,j]quinoline-2-one; 2-(thiocyanomethylthio)benzothiazole; N-trichloromethylthio 4-cyclohexene-1,2-dicarboxyimide; silver; copper; N-(trichloromethylthio)phthalimide; validamycin; zinc ethylene-bis-(dithiocarbamate); zinc bis-(1-hydroxy-2(1H)pyridinethionate; zinc propylene-bis-(dithiocarbamate); and zinc pyrithione. The most preferable additional biocides would include but are not limited to 2-methyl-4-isothiazolin-3-one, 5-chloro-2-methyl-4-isothiazoline-3-one, 2-octyl-4-isothiazoline-3-one and/or 4,5-dichloro-2-octyl-4-isothiazoline-3-one.

The aqueous compositions of BIT are preferably employed in the fields of, but are not limited to, disinfectants, sanitizers, cleaners, deodorizers, liquid and powder soaps, hide removers, oil and grease removers, food processing chemicals, dairy chemicals, food preservatives, animal food preservatives, wood preservation, polymer latices, paint, lazures, stains, mildewicides, hospital and medical antiseptics, medical devices, metal working fluids, cooling water, air washers, petroleum production, paper treatment, pulp and paper slurries, paper mill slimicides, petroleum products, adhesives, textiles, pigment slurries, latexes, leather and hide treatment, petroleum fuel, jet fuel, laundry sanitizers, agricultural formulations, inks, mining, non-woven fabrics, petroleum storage, rubber, sugar processing, tobacco, swimming pools, photographic rinses, cosmetics, toiletries, pharmaceuticals, chemical toilets, household laundry products, diesel fuel additives, waxes and polishes, oil field applications, building materials, stucco, concrete, caulks, sealants, joint compounds, drilling mud, clay slurries and many other applications where aqueous medium and organic compounds or materials come in contact under these conditions which allow the growth of undesired microorganisms.

Further, the present application is illustrated in detail by way of the below given examples. The examples are given herein for illustrating the best mode of working of the invention and are not intended to be limiting thereof.

### Aqueous-Miscible Compositions

### Example 1

### Control, No Enhanced Activity

| Ingredient | wt % |
|---|---|
| Polyglycol | 24.7 |
| NaOH (50%) | 5.4 |
| Water | 59.7 |
| BIT | 10.2 |

### Example 2

| Ingredient | wt % |
|---|---|
| Polyglycol | 19.7 |
| NaOH (50%) | 5.4 |
| Water | 59.7 |
| Polyimines/polyamines/polyethyleneimines | 5.0 |
| BIT | 10.2 |

A clear stable solution is formed. The product passed all stability test at RT, HA and 5 freeze thaw.

### Example 3

| Ingredient | Wt % |
|---|---|
| Polyglycol | 24.0 |
| fatty acid tertiary amine | 2.0 |
| Salicylic acid/HCl/sulfamic acid | 2.0 |
| Polyimines/polyamines/polyethyleneimines | 1.0 |
| NaOH (50%) | 4.0 |
| Water | 56.8 |
| BIT | 10.2 |

Both Inorganic and organic acids can be utilized to neutralize to increase the solubility of BIT in water thereby enhancing the stability of the product on storage at low or high temp. A clear solution of pH around 8.2 is obtained. The product is free from sludge and precipitate formation at low and high temperature

### Example 4

| Ingredient | Wt % |
|---|---|
| BIT | 10.12 |
| Polyglycol | 19.7 |
| NaOH (50%) | 5.4 |
| Polyimines/polyamines/polyethyleneimines | 1.05 |
| Sodium gluconate/Zinc gluconate/ | 1.05 |
| Copper gluconate | |
| Water | 62.64 |

Clear and low and high temperature stable formulation with pH around 8.3

### Example 5

| Ingredient | Wt % |
|---|---|
| BIT | 22.0 |
| Polyglycerol 3 | 2.0 |
| Salicylic acid | 3.0 |
| NaOH (50%) | 8.0 |
| Water | 60.0 |
| Diocytlyl sulfosuccinate sodium | 5.0 |

A clear and low and high temperature stable formulation with pH around 8.2 is formed.

### Example 6

| Ingredient | Wt % |
|---|---|
| BIT | 22.0 |
| cationic amine surfactant | 9.0 |
| Salicylic acid/citric acid | 6.0 |
| Dioscytl sulfosuccinate sodium | 2.0 |
| Polyglycerol 3 | 2.0 |
| Water | 59.0 |

A stable formulation around pH 8.5 is obtained

### Example 7

| Ingredient | Wt % |
|---|---|
| Poly glycol PT 250 | 53.62 |
| BIT | 10.2 |
| Polyimines/polyamines/polyethyleneimines | 1.05 |
| Sodium gluconate | 2.0 |
| Fatty acid tertiary amine and tertiary amines | 3.0 |
| NaOH (50%) | 1.0 |
| HCl (37%) | 0.18 |
| Water | 25.0 |

A very stable solution is obtained on very low use level of NaOH and the pH is around 8.2. More solvent level of PT 250 increases the stability at low pH when higher level of water is incorporated into the formulation.

### Example 8

| Ingredient | Wt % |
|---|---|
| Water | 61.63 |
| BIT | 10.12 |
| Polyol | 14.7 |
| Cyclopenanediol | 10.0 |
| Polyimines/Polyamines/Polyethyleneimines | 2.1 |
| Sodium gluconate | 1.05 |
| Benzaldehyde/Salicylaldehyde/Cinnamaldehyde | 1.2 |
| NaOH | 5.4 |

### Example 9

| Ingredient | Wt % |
|---|---|
| Water | 61.63 |
| BIT | 10.12 |
| Polyol | 9.7 |
| NaOH | 5.4 |
| Cyclopentanediol | 10.0 |
| Alkyl fatty acid tertiary amine | 2.1 |
| Salicylaldehyde/Cinnamaldehyde | 2.0 |
| Sodium salicylate | 1.05 |

### Example 10

| Ingredient | Wt % |
|---|---|
| Water | 75.53 |
| MIT | 10.12 |
| Polyol | 9.7 |
| Polyimin/Polyamin/Polethyleneimine | 2.1 |
| Sodium gluconate | 1.05 |
| Salicaldehyde | 1.2 |
| Cyclohexanediol | 10.0 |

### Example 11

| Ingredient | Wt % |
|---|---|
| Water | 56.73 |
| Octyl-isothiazolinone (OIT) | 10.12 |
| NaOH | 5.4 |
| Cyclopentane diol | 19.7 |
| Alkyl fatty acid tertiary amine | 5.0 |
| Salicylaldehyde/cinnamaldehyde | 2.0 |
| Sodium gluconate | 1.05 |

### Example 12

| Ingredient | Wt % |
|---|---|
| Water | 58.0 |
| MIT | 5.2 |
| Octyl-isothiazolinone (OIT) | 5.2 |
| BIT | 10.2 |
| Polyimines/Polyamines/Polyethyleneimine | 2.0 |
| Sodium gluconate | 2.0 |
| Salicylaldehyde/cinnamaldehyde | 2.0 |
| NaOH | 5.4 |
| Unixol | 10.0 |

Mix them until a clear solution is formed.

### Aqueous-Dispersible Compositions

### Example 13

| Ingredients | wt % |
|---|---|
| Water | 56.5 |
| BIT | 23.8 |
| Polyimine/Polyamine/Polyethyleneimine | 5.0 |
| Sodium salicylate | 5.0 |
| Silica | 1.5 |
| Xanthan gum | 0.5 |
| Poloxamer | 1.7 |
| Ethoxylated acetylenic diols | 1.0 |
| Tertiary amines derivatives of fatty acid | 5.0 |

### Example 14

| Ingredients | wt % |
|---|---|
| Water | 59.8 |
| BIT | 25.0 |
| Salicylaldehyde | 2.0 |
| Zn-Gluconate | 2.0 |
| Silica | 1.5 |
| Xanthan gum | 2.0 |
| Poloxamer | 1.7 |
| Ethoxylated acetylenic diols | 1.0 |
| Tertiary alkyl fatty amine | 5.0 |

### Example 15

| Ingredients | wt % |
|---|---|
| Water | 61.3 |
| BIT | 25.0 |
| Polyimine/Polyamine/Polyethyleneimine | 5.0 |
| Zn or Na Gluconate | 5.0 |
| Silica | 1.0 |
| Xanthan gum | 0.5 |
| Poloxamer | 1.5 |
| Ethoxylated acetylenic diols | 0.7 |

### Example 16

| Ingredients | wt % |
|---|---|
| Water | 74.0 |
| BIT | 10.2 |
| MIT | 5.2 |
| OIT | 5.2 |
| Easy Sperse P 20 | 0.5 |
| Aerosol OT 100 | 0.5 |
| Polyamine/Polyimine/Polyethyleneimine | 2.0 |
| Salicylaldehyde/Cinnamaldehye | 2.0 |
| Xanthan gum | 0.4 |

The ingredients are added together and ground by Zirconium beads until Hegmann 7 is attained.

### Example 17

### Evaluation of Antimicrobial Activity

Serial dilution in Trypticase Soy Broth (TSB, commercially available) was performed with composition, as described above. Broth was inoculated with various Pseudomonas strains (field isolates) and ATCC cultures. After 24 hours incubation at 32° C. all tubes which did not become cloudy in the series dilution test (no visible growth) were smeared onto Tryptic Soy Agar (TSA) and incubated for 24 hr at 32° C. That value at which no growth was detected was determined as the MIC. Results are shown in Table 1.

TABLE 1
MIC against different Pseudomonas strains of various BIT compositions

| Pseudomonas species | Example 2 | Example 4 | Example 1 |
|---|---|---|---|
| P. olevorans (field isolate) | 62.5 | 125.0 | 250.0 |
| P. alcolipha (field isolate) | 125.0 | 62.5 | 250.0 |
| P. alcolipha (field isolate) | 62.5 | 62.5 | 125.0 |
| P. aeruginosa (field isolate) | 250.0 | 250.0 | 500.0 |
| P. aeruginosa (ATCC 10145) | 125.0 | 250.0 | 250.0 |

### Example 18

### Rate of Kill of Various Compositions

The rate of kill of the various BIT formulations was determine by preparing a TSB solution to contain 500 ppm of BIT, and at time=0 hr adding a P. aeruginosa (ATCC 10145) suspension to a final concentration of about 10⁶ CFU/ml. Samples were taken at various time intervals and plated on TSA. Plates were incubated at 32° C. for 24 hours and numbers of colonies were counted and Log CFU/ml calculated, Results are presented in Table 2

TABLE 2
Rate of Kill of various BIT formulations against P. aeruginosa ATCC
10145

| Composition | 0 hr | 2 hr | 4 hr | 6 hr |
|---|---|---|---|---|
| Example 2 | 6.6 | 5.4 | 3.1 | <1.0 |
| Example 4 | 6.5 | 5.4 | 4.0 | <1.0 |
| Example 1 | 6.6 | 5.6 | 4.2 | <1.0 |

While this application has been described in detail with reference to certain preferred embodiments, it should be appreciated that the present application is not limited to those precise embodiments. Rather, in view of the present disclosure, which describes the current best mode for practicing the application, many modifications and variations would present themselves to those skilled in the art without departing from the scope and spirit of this invention.

What is claimed is:

1. An aqueous-miscible or aqueous-dispersible, volatile organic compounds (VOC)-free, heat and cold stable biocidal composition having pH of about 3.0 to about 8.5 capable of exhibiting substantially enhanced biocidal activity via enhanced inhibition of gram-negative bacterial strains comprising:
i. 1,2-benzisothiazolin-3-one (BIT);
ii. at least one cationic polymer and/or at least one cationic amine surfactant;
iii. optionally one or more sequestering agents;
iv. optionally one or more aromatic aldehydes; and
v. optionally, at least one additive.

2. The aqueous-miscible or aqueous-dispersible biocidal composition according to claim 1, wherein said cationic polymer is selected from the group consisting of homo or copolymers of polyamines, polyimines, polyalkyleneimines, polyethyleneimines, polypropyleneimines alone or in combination.

3. The aqueous-miscible or aqueous-dispersible biocidal composition according to claim 1, wherein said cationic amine surfactant is selected from the group consisting of alkanolamines, mono-alkyl alkanolamines, di-alkyl alkanolamines, tri-alkyl alkanolamines, primary amines, secondary amines, tertiary amines, quaternary amines and/or alkyl tertiary amines.

4. The aqueous-miscible or aqueous-dispersible biocidal composition according to claim 1, wherein said sequestering agent is selected from the group consisting of hydroxy-carboxylic acids, aminocarboxylic acids, phosphonic acids, crown ethers, amino acids, ethylene diamine tetraacetic acid, nitrosotrihydroxy-dipropylamine, nitriloacetate, acetyl salicylate and/or gluconic acid salts.

5. The aqueous-miscible or aqueous-dispersible biocidal composition according to claim 1, wherein said aromatic aldehyde is selected from the group consisting of aromatic aldehydes, benzaldehyde, salicylaldehyde, naphthaldehyde or their derivatives alone or in combination.

6. The aqueous-miscible or aqueous-dispersible biocidal composition according to claim 1, wherein said gram-negative bacterial strain is selected from the group comprising Escherichia species, Salmonella species, Shigella species, Enterobacteriaceae species, Pseudomonas species, Moraxella species, Helicobacter species, and/or Legionella species.

7. The aqueous-miscible or aqueous-dispersible biocidal composition according to claim 1, wherein volatile organic compounds (VOC)-free solvent is selected from the group consisting of glycol, ethers of glycol, esters of glycol, ethylene glycol, propylene glycol, butylene glycol, dipropylene glycol, diethylene glycol, polyglycol, glycerol, ether or esters of glycerol, diglycerol, triglycerol, tetraglycerol, pentaglycerol, hexaglycerol, cyclic diol, non-cyclic diol, polyglycerol or their derivatives alone or in combination.

8. The aqueous-miscible or aqueous-dispersible biocidal composition according to claim 1, wherein said additive is selected from the group consisting of wetting agents, suspending agents, thickening agents, emulsifying agent, dispersing agents, inert carriers, metal oxides, preservatives, pH modifiers, anionic surfactant alone or in combination.

9. The aqueous-miscible or aqueous-dispersible biocidal composition according to claim 8, wherein said pH modifying agent is selected from the group consisting of alkali metal hydroxides, amines, inorganic acids, hydrochloric acid, acetic acid, salicylic acid, citric acid, sulfamic acid alone or in combination.

10. The aqueous-miscible or aqueous-dispersible biocidal composition according to claim 8, wherein said anionic surfactant is selected from the group consisting of hydroxyalkanesulfonates, alkanesulfonates, dialkylsulfosuccinates, straight-chain alkylbenzenesulfonates, branched alkylbenzenesulfonates, alkylnaphthalenesulfonates, aliphatic monoglycerides, higher alkyl sulfates, alkyl aryl sulfonates, higher alkyl sulfoacetates alone or in combination.

11. The aqueous-miscible or aqueous-dispersible composition according to claim 8, wherein said inert carrier is selected from the group consisting of ground natural minerals, ground synthetic minerals, metal oxides and preferably selected from the group consisting of clays, talc, chalk, quartz, attapulgite, montmorillonite or diatomacious earth, perlite, zeolite, highly-disperse silica, alumina, titanium dioxide and silicates alone or in combination thereof.

12. The dispersion composition according claim 8, wherein said dispersing agent is selected from the group consisting of copolymers of 2-pyrrolidone and methoxy ethene sodium salt, EO/PO block copolymer, polymers of acrylic and methacrylic acids, C₁₁-C₁₅ secondary ethoxylated alcohol, diols and/or polyether polyols.

13. The dispersion composition according claim 8, wherein said suspending or thickening agent is selected from the group consisting of hydrocolloid gums, cellulose derivatives polysaccharide derivatives, xanthan gum, guar gum, hydroxymethyl cellulose hydroxypropyl methyl cellulose (HPMC), hydroxyproyl ethyl cellulose (HPEC) and/or hydrophobically modified starch to uniformly suspend the finely divided particles.

14. The dispersion composition according claim 8, wherein said wetting agent is selected from the group consisting of alkoxylated acetylenic diols and/or 2,4,7,9-tetramethyl-5-decyne-4,7-diol.

15. The aqueous-miscible or aqueous-dispersible biocidal composition according to claim 1, wherein the composition is stable for at least two years at room temperature or stable for at least 5 freeze/thaw cycles wherein temperature cycled from 50° C. to −24° C. in every 24 hours or stable for at least 4 weeks at about 50° C.

16. The aqueous-miscible or aqueous-dispersible biocidal composition according to claim 1 formulated as an emulsion, suspension or concentrate.

17. The aqueous-miscible or aqueous-dispersible biocidal composition according to claim 1, further comprising one or more biocides selected from the group consisting of insecticides, acaricides, algicides, molluscicides, bactericides, herbicides, plant growth regulators and/or fungicides.

18. A process for preparing an aqueous-miscible, volatile organic compounds (VOC)-free, heat and cold stable, biocidal composition comprising the steps of:
i. preparing an aqueous glycolic dispersion of 1,2-benzisothiazolin-3-one (BIT) with continuous stirring;
ii. neutralizing the resultant obtained in the step (i) with at least one appropriate pH adjusting agents until it yields clear solution; and
iii. adding (a) cationic polymer, (b) cationic surfactant, (c) other optional ingredients including sequestering agents and aromatic aldehydes and (d) optionally, at least one additive to the resulting neutralized solution of step (ii) with thorough mixing until it yields a clear transparent aqueous-miscible solution.

19. A process for preparing an aqueous-dispersible, volatile organic compounds (VOC)-free, heat and cold stable, biocidal composition comprising the steps of:
i. preparing an aqueous medium comprising uniformly dispersed particles of mixture of wetting agent, inert carrier and dispersing agent by means of appropriate stirring techniques;
ii. adding 1,2-benzisothiazolin-3-one (BIT) and at least one cationic surfactant to the resultant aqueous uniform dispersion of step (i) and grinding the resulting mixture for at least 30 minutes employing zirconium beads as grinding media; and
iii. incorporating (a) cationic polymer, (b) optional ingredients including sequestering agents and aromatic aldehydes, and (c) optionally, at least one additive to the resultant uniform mixture of step (ii) and grinding the collective mixture employing zirconium beads as grinding media until the Hegmann number is 7.0.

20. The aqueous-miscible or aqueous-dispersible, biocidal composition according to claim 1 employed in the field of paint, building materials, stucco, concrete, caulks, sealants, joint compounds, adhesives, leather, wood, inks, pigment dispersions, metal working fluids, drilling mud and/or clay slurries.
